(19) United States
(12) Patent Application Publication
(10) Pub. No.: US 2020/0407661 A1
(43) Pub. Date: Dec. 31, 2020

(54) LIQUID DISHWASHING DETERGENT COMPOSITION

(71) Applicant: The Procter & Gamble Company, Cincinnati, OH (US)

(72) Inventors: Karl Ghislain BRAECKMAN, Gerpinnes (BE); Susana FERNANDEZ PRIETO, Benicarlo Castellon (ES); Pieter Jan Maria SAVEYN, Destelbergen (BE); Johan SMETS, Lubbeek (BE); Evelyne Johanna Lutgarde VANHECKE, Bachte-Maria-Leeme (BE)

(21) Appl. No.: 16/909,190

(22) Filed: Jun. 23, 2020

(30) Foreign Application Priority Data
Jun. 28, 2019 (EP) 19183192.4
Dec. 23, 2019 (EP) 19219341.5

(51) Int. Cl. C11D 1/94; C11D 11/00; C11D 17/00; C11D 17/04; C11D 3/22; C11D 3/04

(52) U.S. Cl. CPC C11D 1/945; C11D 11/0023; C11D 17/0013; C11D 1/29; C11D 3/222; C11D 3/044; C11D 3/046; C11D 17/046

(57) ABSTRACT

The need for a liquid hand dishwashing composition which provides for uniform dosing, even when the bottle is shaken or when the user dispenses using multiple successive squeezes, is met by formulating the liquid hand dishwashing composition with an anionic surfactant, a co-surfactant, and microfibrous cellulose derived from wood.

### FIELD OF THE INVENTION

### Background of the Invention

Hand dishwashing detergent compositions should have good sudsing profile while providing good cleaning of dishes, including hard to remove greasy soils. In addition, users have a high preference for dishwashing compositions which are clear or have a high translucency. Further improvements in the usage experience can be achieved through formulating the composition to have a higher viscosity, since a higher viscosity often indicates a richness in the formula and higher efficacy. The compositions are typically formulated with a higher viscosity to improve the dosing experience. Indeed, lower viscosity detergent compositions tend to run out more quickly and more variably, leading to a higher consumption rate and inconsistent dosing. To provide a more consistent dosing experience, a target viscosity is typically defined as a function of the orifice size of the liquid detergent bottle, with a higher liquid product viscosity typically being used in combination with a larger orifice size. In order to provide the higher viscosity, a structurant can typically be added to the detergent composition. However, it has been found that even with such structurant containing detergent compositions, it can be difficult to control the dispensed amount through narrow apertures, as found on many bottles used for containing liquid hand dishwashing detergent compositions. In particular, it has been observed that many users over-dispense the liquid detergent composition when they either shake the bottle or squeeze the bottle multiple times before dispensing the detergent composition. It is believed that the structure in the liquid detergent composition is partially destroyed upon shaking or squeezing the bottle, leading to a lower than targeted product viscosity, which in turn, leads to over-dosing the detergent composition. As a result, the liquid hand dishwashing detergent composition is used up more quickly which leads to decreased satisfaction by the user.

Hence, a need remains for a liquid hand dishwashing composition which provides for uniform dosing, even when the bottle is shaken or when the user dispenses while using multiple successive squeezes.

WO2015006634 relates to the use of microfibrillated cellulose, derived from vegetables or wood, to provide a liquid composition which is compatible with a broad range of ingredients suitable for consumer applications, including enzymes, while still providing good structuring of the liquid composition, without affecting ease of pour. WO2009101545 relates to a structured liquid detergent composition in the form of a liquid matrix made up of an external structuring system of a bacterial cellulose network; water; and surfactant system including an anionic surfactant; a nonionic surfactant; a cationic surfactant; an ampholytic surfactant; a zwitterionic surfactant; or mixtures thereof, wherein said liquid matrix has a yield stress of from about 0.003 Pa to about 5.0 Pa at about 25° C. and which provides suitable particle suspension capabilities and shear thinning characteristics. WO201709042 and WO2018184824 relate to liquid cleaning compositions comprising one or more detergent surfactants, comprising water, one or more detergent surfactants, electrolytes, abrasive particles and defibrillated primary cell wall material comprising microfibrils. WO2013152992 relates to the cleaning performance of detergents and cleansers which comprise microfibrillar cellulose.

### SUMMARY OF THE INVENTION

The present invention relates to a liquid hand dishwashing detergent composition comprising: from 5% to 50% by weight of the total composition of a surfactant system, wherein the surfactant system comprises anionic surfactant and a co-surfactant selected from the group consisting of an amphoteric surfactant, a zwitterionic surfactant and mixtures thereof; and from 0.001 to 2.0% by weight of the total composition of microfibrillated cellulose derived from wood.

The present invention further relates to a packaged product comprising a container having an orifice, wherein the orifice has an open cross-sectional surface area at the exit of from 3 mm² to 20 mm², preferably from 3.8 mm² to 12 mm², more preferably from 5 mm² to 10 mm², wherein the container further comprises such compositions.

### DETAILED DESCRIPTION OF THE INVENTION

Uneven dispensing of structured liquid hand dishwashing detergent compositions can at least in part be associated to slow recovery of the viscosity after shaking or squeezing of the container. This is particularly noticeable for users who dose using short, repeated squirts. It has been found that structuring the liquid hand dishwashing detergent using microfibrillated cellulose derived from wood results in a more rapid viscosity recovery after shear, and hence more even dosing.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a detergent composition relating to suds character during the dishwashing process. The term “sudsing profile” of a detergent composition includes suds volume generated upon dissolving and agitation, typically manual agitation, of the detergent composition in the aqueous washing solution, and the retention of the suds during the dishwashing process. Preferably, hand dishwashing detergent compositions characterized as having “good sudsing profile” tend to have high suds volume and/or sustained suds volume, particularly during a substantial portion of or for the entire manual dishwashing process. This is important as the consumer uses high suds as an indicator that sufficient detergent composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing detergent composition will tend to be replaced by the consumer more frequently than is necessary because of the low sudsing level.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Detergent Composition

The detergent composition is a hand dishwashing detergent composition in liquid form. The detergent composition is preferably an aqueous detergent composition. As such, the composition can comprise from 50% to 90%, preferably from 60% to 75%, by weight of the total composition of water.

Preferably, the pH of the composition is from about 6 to about 14, preferably from about 7 to about 12, or more preferably from about 7.5 to about 10, as measured at 10% dilution in distilled water at 20° C. The pH of the composition can be adjusted using pH modifying ingredients known in the art.

The composition of the present invention is typically non-Newtonian, and preferably shear thinning Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, measured at a shear-rate of 1 s⁻¹ at a temperature of 20° C. Preferably, the composition has a viscosity of from 1 mPa·s to 3,000 mPa·s, preferably from 25 mPa·s to 1,500 mPa·s, more preferably from 50 mPa·s to 750 mPa·s, or most preferably from 100 mPa·s to 500 mPa·s, measured at a shear-rate of 250 s⁻¹ at a temperature of 20° C. The viscosity is measured using a Haake MARS Modular Advanced Rheometer System from Thermo scientific, fitted with a 60 mm 1° cone and plate geometry with a 52 micron gap. The detergent composition should be left to rest in the cone and plate cell for 2 minutes and viscosity measured once equilibrium has been reached.

### Surfactant System

The liquid hand dishwashing detergent composition comprises from 5% to 50%, preferably from 10% to 40%, more preferably from 25% to 35%, by weight of the total composition of a surfactant system.

For improved sudsing, the surfactant system comprises anionic surfactant. The surfactant system preferably comprises from 60% to 90% by weight of the surfactant system of the anionic surfactant. Alkyl sulphated anionic surfactants are preferred, particularly those selected from the group consisting of: alkyl sulphate, alkyl alkoxy sulphate, and mixtures thereof. More preferably, the anionic surfactant consists of alkyl sulphated anionic surfactant selected from the group consisting of: alkyl sulphate, alkyl alkoxy sulphate, and mixtures thereof.

For further improvements in sudsing, the surfactant system can comprise less than 30%, preferably less than 15%, more preferably less than 10% of further anionic surfactant, and most preferably the surfactant system comprises no further anionic surfactant. The alkyl sulphated anionic surfactant can have an average alkyl chain length of from 8 to 18, preferably from 10 to 14, more preferably from 12 to 14, most preferably from 12 to 13 carbon atoms. The alkyl sulphated anionic surfactant has an average degree of alkoxylation, of less than 5, preferably less than 3, more preferably from 0.5 to 2.0, most preferably from 0.5 to 0.9. Preferably, the alkyl sulphated anionic surfactant is ethoxylated. That is, the alkyl sulphated anionic surfactant has an average degree of ethoxylation, of less than 5, preferably less than 3, more preferably from 0.5 to 2.0, most preferably from 0.5 to 0.9.

The average degree of alkoxylation is the mol average degree of alkoxylation (i.e., mol average alkoxylation degree) of all the alkyl sulphate anionic surfactant. Hence, when calculating the mol average alkoxylation degree, the mols of non-alkoxylated sulphate anionic surfactant are included:

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each alkyl (or alkoxy) sulphate anionic surfactant of the mixture and alkoxylation degree is the number of alkoxy groups in each alkyl sulphate anionic surfactant.

The alkyl sulphate anionic surfactant can have a weight average degree of branching of more than 10%, preferably more than 20%, more preferably more than 30%, even more preferably between 30% and 60%, most preferably between 30% and 50%. The alkyl sulphate anionic surfactant can comprise at least 5%, preferably at least 10%, most preferably at least 25%, by weight of the alkyl sulphate anionic surfactant, of branching on the C2 position (as measured counting carbon atoms from the sulphate group for non-alkoxylated alkyl sulphate anionic surfactants, and the counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the detergent composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulphate anionic surfactant.

The alkyl chain of the alkyl sulphated anionic surfactant preferably has a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 50/50, preferably at least 57/43, preferably from 60/40 to 90/10, more preferably from 60/40 to 80/20, most preferably from 60/40 to 70/30, while not compromising suds mileage in the presence of particulate soils.

Suitable counterions include alkali metal cation earth alkali metal cation, alkanolammonium or ammonium or substituted ammonium, but preferably sodium.

Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

In order to improve surfactant packing after dilution and hence improve suds mileage, the surfactant system comprises a co-surfactant. Preferred co-surfactants are selected from the group consisting of an amphoteric surfactant, a zwitterionic surfactant, and mixtures thereof. The co-surfactant is preferably an amphoteric surfactant, more preferably an amine oxide surfactant. The co-surfactant is included as part of the surfactant system.

The composition preferably comprises from 0.1% to 20%, more preferably from 0.5% to 15% and especially from 2% to 10% by weight of the detergent composition of the co-surfactant. The surfactant system of the detergent composition of the present invention preferably comprises from 10% to 40%, preferably from 15% to 35%, more preferably from 20% to 30%, by weight of the surfactant system of a co-surfactant. The anionic surfactant to the co-surfactant weight ratio can be from 1:1 to 8:1, preferably from 2:1 to 5:1, more preferably from 2.5:1 to 4:1.

Amine oxide surfactants are preferred for use as a co-surfactant. The amine oxide surfactant can be linear or branched, though linear are preferred. Suitable linear amine oxides are typically water-soluble, and characterized by the formula R1-N(R2)(R3)O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the Phosphobetaine, and preferably meets formula (I):

R¹—[CO—X(CH₂)ₙ]ₓ—N⁺(R²)(R₃)—(CH₂)ₘ—[CH(OH)—CH₂]_{y}—Y⁻

wherein in formula (I),

R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR4 wherein R4 is a C1-4 alkyl residue, O, and S,

n is an integer from 1 to 10, preferably 2 to 5, more preferably 3,

x is 0 or 1, preferably 1,

R2 and R3 are independently selected from the group consisting of: a C1-4 alkyl residue, hydroxy substituted such as a hydroxyethyl, and mixtures thereof, preferably both R2 and R3 are methyl,

m is an integer from 1 to 4, preferably 1, 2 or 3,

y is 0 or 1, and

Y is selected from the group consisting of: COO, SO3, OPO(OR5)O or P(O)(OR5)O, wherein R5 is H or a C1-4 alkyl residue.

Preferred betaines are the alkyl betaines of formula (IIa), the alkyl amido propyl betaine of formula (IIb), the sulphobetaines of formula (IIc) and the amido sulphobetaine of formula (IId):

R¹—N(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)

in which R1 has the same meaning as in formula (I). Particularly preferred are the carbobetaines [i.e. wherein Y⁻═COO— in formula (I)] of formulae (IIa) and (IIb), more preferred are the alkylamidobetaine of formula (IIb).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of a non-ionic surfactant.

Suitable nonionic surfactants can be selected from the group consisting of: alkoxylated non-ionic surfactant, alkyl polyglucoside (“APG”) surfactant, and mixtures thereof.

Suitable alkoxylated non-ionic surfactants can be linear or branched, primary or secondary alkyl alkoxylated non-ionic surfactants. Alkyl ethoxylated non-ionic surfactant are preferred. The ethoxylated non-ionic surfactant can comprise on average from 9 to 15, preferably from 10 to 14 carbon atoms in its alkyl chain and on average from 5 to 12, preferably from 6 to 10, most preferably from 7 to 8, units of ethylene oxide per mole of alcohol. Such alkyl ethoxylated nonionic surfactants can be derived from synthetic alcohols, such as OXO-alcohols and Fisher Tropsh alcohols, or from naturally derived alcohols, or from mixtures thereof. Suitable examples of commercially available alkyl ethoxylate nonionic surfactants include, those derived from synthetic alcohols sold under the Neodol® brand-name by Shell, or the Lial®, Isalchem®, and Safol® brand-names by Sasol, or some of the natural alcohols produced by The Procter & Gamble Chemicals company.

The compositions of the present invention can comprise alkyl polyglucoside (“APG”) surfactant. The addition of alkyl polyglucoside surfactants have been found to improve sudsing beyond that of comparative nonionic surfactants such as alkyl ethoxylated surfactants. Preferably the alkyl polyglucoside surfactant is a C8-C16 alkyl polyglucoside surfactant, preferably a C8-C14 alkyl polyglucoside surfactant. The alkyl polyglucoside preferably has an average degree of polymerization of between 0.1 and 3, more preferably between 0.5 and 2.5, even more preferably between 1 and 2. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

Microfibrillated Cellulose Derived from Wood

External structurants are dispersed actives that provide a viscosity or structuring benefit in addition to any internal structuring effect of the surfactants or of surfactant-cosolute interactions in the composition. For instance, the external structurant can impart a shear thinning viscosity profile to a liquid composition, in addition to any internal structuring effect of the detersive surfactants or of surfactant-co-solute interactions in the composition. One such external structurant is microfibrillated cellulose. Microfibrillated cellulose can be derived from different origins, more particularly from bacterial origin or from botanical origins such as fruits, vegetables, plants and wood. The source material for the microfibrillated cellulose determines the fibre length, crystallinity and other properties of the microfibrous cellulose. As such, the source of the microfibrillated cellulose can affect the performance of the cellulose, including such aspects as the amount needed to build viscosity, resistance to certain enzymes, and the like. For example, hemicellulose, lignin, and pectin can be major non-cellulosic components of most primary plant cell walls of the source material and hence the microfibrillated cellulose derived from the source material.

There are different types of hemicelluloses, including xylan, glucuronoxylan, arabinoxylan, glucomannan, and xyloglucan. Hemicelluloses are polysaccharides often associated with cellulose, and contain many different sugar monomers, while cellulose only contains anhydrous glucose. For instance, besides glucose, sugar monomers in hemicelluloses can include the five-carbon sugars xylose and arabinose, the six-carbon sugars mannose and galactose, and the six-carbon deoxy sugar rhamnose. Hemicelluloses contain most of the D-pentose sugars, and occasionally small amounts of L-sugars as well. Xylose is in most cases the sugar monomer present in the largest amount, although in softwoods mannose can be the most abundant sugar. Not only regular sugars can be found in hemicellulose, but also their acidified form, for instance glucuronic acid and galacturonic acid can be present. Unlike cellulose, hemicelluloses typically consists of shorter chains of from 500 to 3,000 sugar units, in contrast to the 7,000 to 15,000 glucose molecules typically present in cellulose. In addition, hemicellulose comprises branched polymers, while cellulose is typically unbranched. Wood typically comprises from 15% to 35% of hemicellulose, with hard woods such as Scots pine and Spruce being preferred as a source for the microfibrillated cellulose, since they contain hemicellulose at levels of from 25% to 35% by weight of the chemical composition of wood (excluding the water). Wood typically comprises lignin at a level of from 20% to 30% by weight of the chemical composition of wood (excluding the water), with hard woods such as Scots pine and Spruce containing lignin at levels of from 25% to 30% by weight of the chemical composition of wood (excluding the water). Any suitable method can be used to measure the chemical composition of the wood, such as that described in Sjostrom, E., Wood Chemistry. Fundamentals and Applications. Second edition ed. 1993, San Diego: Academic press. 292. Wood, and hence microfibrillated cellulose derived from would typically comprises less than 100.0 mg total pectin monosaccharides per g of microfibrillated cellulose, more typically less than 80.0 mg total pectin monosaccharides per g of microfibrillated cellulose, still more typically less than 40.0 mg total pectin monosaccharides per g of microfibrillated cellulose. Obviously, much higher levels of pectin are typically present in citrous fruits and hence microfibrillated cellulose derived from citrous feedstock.

It is believed that non-cellulosic components such as hemicelluloses, especially xyloglucan, and pectin function interact with the cellulose and as a result, affect the viscoelastic properties of compositions comprising the microfibrillated cellulose.

For example, depending on the source of the microfibrillated cellulose, lower levels of microfibrillated cellulose can be required in order to provide the desired level of viscosity. It has also been found that the speed at which the microfibrillated cellulose rebuilds its network after shearing is also affected by the source of the microfibrillated cellulose.

It has surprisingly been found that liquid hand dishwashing compositions comprising a surfactant system according to the invention and microfibrillated cellulose derived from wood recover their viscosity and yield point surprisingly rapidly after shearing. As a result, dosing is more uniform, even after vigorous shaking. In addition, the phase stability of the liquid hand dishwashing is improved, especially for structured hand dishwashing compositions that further comprise polymer or suspended particles. Wood derived microfibrillated cellulose has also shown decreased viscosensitivity impact, i.e. viscosity variation of the liquid hand dishwashing composition upon small microfibrillated cellulose dosing variations during making. The more controlled finished product viscosity further adds to the improved dosing control of the liquid detergent composition.

The hand dishwashing compositions of the present invention comprises from 0.001 to 2%, preferably from 0.01 to 1.0%, more preferably from 0.05 to 0.5% by weight of the total composition of the microfibrillated cellulose derived from wood.

Microfibrillated cellulose, derived from wood, has been found to be suitable for use as an external structurant, for liquids comprising at least one surfactant. Suitable wood sources, from which the microfibrillated cellulose can be derived, include: spruce, poplar, olive tree, eucalyptus, pinus, robinia, elm, oak, and mixtures thereof, preferably from spruce, eucalyptus, and mixtures thereof, more preferably from spruce. Wood fibres comprise a higher proportion of insoluble fibre than fibres derived from fruits, including citrus fruits. Preferred microfibrillated cellulose are derived from wood which comprise less than 10% soluble fibre as a percentage of total fibre.

Microfibrils, derived from wood, include a large proportion of primary wall cellulose, also called parenchymal cell cellulose (PCC). It is believed that such microfibrils formed from such primary wall cellulose provide improved structuring. In addition, microfibrils in primary wall cellulose are deposited in a disorganized fashion, and are easy to dissociate and separate from the remaining cell residues via mechanical means.

The microfibrillated cellulose is preferably not chemically treated, beyond any hydrolysis treatment to purify the cellulose. For instance, by extracting the pectins and hemicelluloses. Since the wood from which the microfibrillated cellulose is derived is typically low in pectin, such hydrolysis treatment may also not be necessary. As such, more preferred microfibrillated cellulose are not chemically treated. While charged groups can also be introduced into the microfiber cellulose, for instance, via carboxymethylation, as described in Langmuir 24 (3), pages 784 to 795, such chemical modifications are not preferred.

In order to optimise the viscosity, it is desirable to control the length of the microfibrillated cellulose fibres. A measure of the length of the microfibrillated cellulose fibres is the average hydrodynamic diameter. As such, the wood fibers can be processed from the respective raw material such that the microfibrillated cellulose fibers have an average hydrodynamic diameter of from 5 micron to 100 micron, preferably from 10 micron to 75 micron, more preferably from 20 micron to 50 micron. By average hydrodynamic diameter, the volume weight mean hydrodynamic diameter is meant. Such fibers are commercially available, for instance under the Exilva® tradename from Borregaard.

The microfibrillated cellulose fibres can have an average fibre diameter of from 10 nm to 1000 nm, preferably from 25 nm to 500 nm, more preferably from 50 nm to 350 nm.

Liquid compositions, comprising microfibrillated cellulose derived from wood are typically thixotropic, providing good suspension of particles and droplets, while easily flowing under shear. As a result, microfibrillated cellulose derived from wood, is a particularly suitable structurant for surfactant containing liquid compositions, since it stabilises suspended insoluble material in the liquid composition, while reducing phase separation, and being compatible with a wide variety of typical adjuncts, including enzymes. Moreover, such microfibrillated cellulose, derived from wood, are believed to also improve deposition of actives, including perfumes, perfume microcapsules, and the like.

The microfibrillated cellulose can be provided as a structuring premix to allow easier processing into the liquid detergent composition.

### Suspended Insoluble Material

Microfibrillated cellulose derived from wood is particularly effective at stabilizing suspended insoluble material since it provides the liquid composition with a thixotropic rheology profile, and a yield stress which is sufficiently high enough to suspend such insoluble material. The composition preferably comprises sufficient microfibrillated cellulose to provide a yield stress, preferably greater than 0.005 Pa, more preferably from 0.01 to 1 Pa, and most preferably from 0.1 to 1 Pa. As such, the microfibrillated cellulose is suited for stabilizing liquid hand dishwashing compositions which further comprise suspended insoluble material. Suitable suspended insoluble material can be selected from the group consisting of: particulates, insoluble fluids, and mixtures thereof. Suspended insoluble materials are those which have a solubility in the liquid composition of less than 1%, at a temperature of 21° C.

The particulates may be encapsulates such as perfume encapsulates, or care or cleaning additives in encapsulated form. Suitable care or cleaning additives includes enzymes. The particulates may alternatively, or additionally, take the form of insoluble ingredients such as quaternary ammonium materials, insoluble polymers, enzymes, and other known benefit agents. The amount of particulates may be from 0.001 to up to 2% by weight of the total composition.

The liquid composition may optionally comprise a suspended insoluble fluid. Suitable insoluble fluids include silicones, perfume oils, and the like. Perfume oils provide an odour benefit to the liquid composition, or to substrates treated with the liquid composition. When added, such perfumes are added at a level of from 0.1% to 5%, more preferably from 0.3% to 3%, even more preferably from 0.6% to 2% by weight of the liquid composition.

### Polymer:

The composition can comprise a polymer, preferably at a level of from 0.1% to 5%, more preferably from 0.2% to 3%, even more preferably from 0.3% to 2% by weight of the liquid composition. Suitable polymers can be selected from triblock copolymers, amphiphilic alkoxylated polyalkyleneimine, ethoxylated polyalkyleneimine, polyester soil release polymers, and mixtures thereof, preferably triblock copolymers, amphiphilic alkoxylated polyalkyleneimine, and mixtures thereof.

Suitable triblock copolymers comprise alkylene oxide moieties according to Formula (I): (EO)x(PO)y(EO)x, wherein EO represents ethylene oxide, and each x represents the number of EO units within the EO block. Each x is independently a number average between 3 and 50, preferably between 5 and 25, more preferably between 10 and 15. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y is a number average between 5 and 60, preferably between 10 and 40, more preferably between 25 and 35.

The triblock co-polymer can have a ratio of y to each x of from 0.8:1 to 5:1, preferably from 1:1 to 3:1, more preferably from 1.5:1 to 2.5:1. The triblock co-polymer can have an average weight percentage of total EO of between 30% and 50% by weight of the triblock co-polymer. As such, the triblock co-polymer can have an average weight percentage of total PO of between 50% and 70% by weight of the triblock copolymer. It is understood that the average total weight % of EO and PO for the triblock co-polymer adds up to 100%, excluding the end-caps. The end-caps are preferably hydrogen, hydroxyl, methyl, and mixtures thereof, more preferably hydrogen, methyl, and mixtures thereof, and most preferably hydrogen. The triblock co-polymer has a number average molecular weight of between 550 and 8000, preferably between 1000 and 4500, more preferably between 2000 and 3100. Number average molecular weight and compositional analysis of the co-polymer is determined using a 1H NMR spectroscopy (see Thermo scientific application note No. AN52907). It is an established tool for polymer characterization, including number-average molecular weight determination and co-polymer composition analysis.

EO-PO-EO triblock co-polymers are commercially available from BASF such as the Pluronic® PE series, and from the Dow Chemical Company such as Tergitol™ L series. Particularly preferred triblock co-polymer from BASF are sold under the tradenames Pluronic® L44 (MW ca 2200, ca 40 wt % EO), Pluronic® PE6400 (MW ca 2900, ca 40 wt % EO), Pluronic® PE4300 (MW ca 1600, ca 30 wt % EO), and Pluronic® PE 9400 (MW ca 4600, 40 wt % EO). Particularly preferred triblock co-polymer from the Dow Chemical Company is sold under the tradename of Tergitol™ L64 (MW ca 2900, ca 40 wt % EO). The preparation method for such triblock co-polymers is well known to polymer manufacturers.

Suitable amphiphilic polymers can be selected from the group consisting of: amphiphilic alkoxylated polyalkyleneimine and mixtures thereof. Preferably, the amphiphilic alkoxylated polyalkyleneimine is an alkoxylated polyethyleneimine polymer comprising a polyethyleneimine backbone having a weight average molecular weight range of from 100 to 5,000, preferably from 400 to 2,000, more preferably from 400 to 1,000 Daltons. The polyethyleneimine backbone comprises the following modifications:
(i) one or two alkoxylation modifications per nitrogen atom, dependent on whether the modification occurs at an internal nitrogen atom or at an terminal nitrogen atom, in the polyethyleneimine backbone, the alkoxylation modification consisting of the replacement of a hydrogen atom on by a polyalkoxylene chain having an average of about 1 to about 50 alkoxy moieties per modification, wherein the terminal alkoxy moiety of the alkoxylation modification is capped with hydrogen, a C1-C4 alkyl or mixtures thereof;
(ii) a substitution of one C1-C4 alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 50 alkoxy moieties per modification wherein the terminal alkoxy moiety is capped with hydrogen, a C1-C4 alkyl or mixtures thereof; or
(iii) a combination thereof.

A preferred amphiphilic alkoxylated polyethyleneimine polymer has the general structure of formula (II):

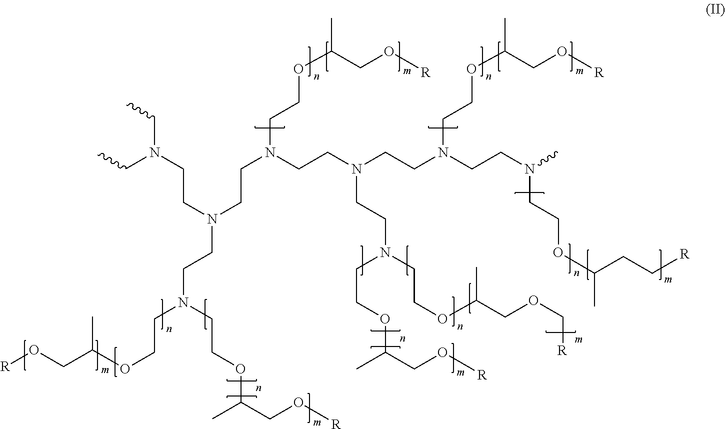

wherein the polyethyleneimine backbone has a weight average molecular weight of about 600, n of formula (II) has an average of about 10, m of formula (II) has an average of about 7 and R of formula (II) is selected from hydrogen, a C₁-C₄ alkyl and mixtures thereof, preferably hydrogen. The degree of permanent quaternization of formula (II) may be from 0% to about 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (II) but wherein the polyethyleneimine backbone has a weight average molecular weight of about 600 Da, n of Formula (II) has an average of about 24, m of Formula (II) has an average of about 16 and R of Formula (II) is selected from hydrogen, a C₁-C₄ alkyl and mixtures thereof, preferably hydrogen. The degree of permanent quaternization of Formula (II) may be from 0% to about 22% of the polyethyleneimine backbone nitrogen atoms, and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the alkoxylated polyalkyleneimine polymer can be an ethoxylated polyalkyleneimine which comprises no further alkoxylation, and as such, is hydrophilic rather than amphiphilic. That is, the ethoxylated polyalkyleneimine comprises no further alkoxylation such as propoxylation or butoxylation. Preferred ethoxylated polyalkyleneimines consist of alkyleneimine monomer units and ethoxylation (-EO-) monomer units, with the exception of any end-caps, which are typically hydrogen. Ethyleneimine monomer units are highly preferred alkyleneimine monomer units. More preferably, the hydrophilic ethoxylated polyethyleneimine polymer has the general structure of formula (II) but wherein the polyethyleneimine backbone has a weight average molecular weight of about 600 Da, n of Formula (II) has an average of about 20, m of Formula (II) is zero and R of Formula (II) is selected from hydrogen, a C₁-C₄ alkyl and mixtures thereof, preferably hydrogen. The degree of permanent quaternization of Formula (II) may be from 0% to about 22% of the polyethyleneimine backbone nitrogen atoms, and is preferably 0%. The molecular weight of this ethoxylated polyethyleneimine polymer preferably is between 10,000 and 15,000, most preferably 12,600 Da.

Polyester soil release agents are also suitable polymers. Soil release agents are polymers having soil release properties, i.e. having the property to enhance the cleaning efficacy of the detergent composition by improving release of greasy and oil during the laundry process. See soil release agents' definition, p. 278-279, “Liquid Detergents” by Kuo-Yann Lai.

Suitable polyester soil release agents can encompass simple copolymeric blocks of ethylene terephthalate or propylene terephthalate with polyethylene oxide or polypropylene oxide terephthalate (see U.S. Pat. Nos. 3,959,230 and 3,893,929). Other suitable polyester soil release agents can be polyesters with repeat units containing 10-15% by weight of ethylene terephthalate together with 90-80% by weight of polyoxyethylene terephthalate, derived from a polyoxyethylene glycol of average molecular weight 300-5,000. Commercial examples include ZELCON® 5126 from Dupont and MILEASE®T from ICI. Suitable polymeric soil release agents can be prepared by art-recognized methods. U.S. Pat. Nos. 4,702,857 and 4,711,730 describe the preferred method of synthesis for the block polyesters of use.

### Cyclic Polyamine

The composition can comprise a cyclic polyamine having amine functionalities that helps cleaning. The composition of the invention preferably comprises from about 0.1% to about 3%, more preferably from about 0.2% to about 2%, and especially from about 0.5% to about 1%, by weight of the composition, of the cyclic polyamine.

The amine can be subjected to protonation depending on the pH of the cleaning medium in which it is used. Preferred cyclic polyamines have the following Formula (IV):

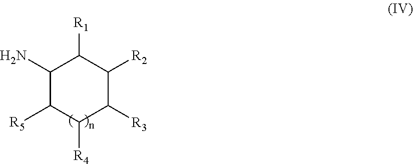

wherein R₁, R₂, R₃, R₄ and R₅ are independently selected from the group consisting of NH2, —H, linear or branched alkyl having from about 1 to about 10 carbon atoms, and linear or branched alkenyl having from about 1 to about 10 carbon atoms, n is from about 1 to about 3, preferably n is 1, and wherein at least one of the Rs is NH2 and the remaining “Rs” are independently selected from the group consisting of NH2, —H, linear or branched alkyl having about 1 to about 10 carbon atoms, and linear or branched alkenyl having from about 1 to about 10 carbon atoms. Preferably, the cyclic polyamine is a diamine, wherein n is 1, R₂ is NH2, and at least one of R₁, R₃, R₄ and R₅ is CH3 and the remaining Rs are H.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the detergent composition of the present invention are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

### Additional Ingredients:

The composition of the present invention may further comprise at least one active selected from the group consisting of: i) a salt, ii) a hydrotrope, iii) an organic solvent, and mixtures thereof. Such actives are effective for modifying the viscosity of the liquid hand dishwashing detergent composition.

The composition of the present invention may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

The composition of the present invention may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol.

### Adjunct Ingredients

The hand dishwashing detergent composition may optionally comprise a number of other adjunct ingredients such as builders (preferably citrate), chelants, conditioning polymers, other cleaning polymers, surface modifying polymers, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm.

The orifice can have an open cross-sectional surface area at the exit of from 3 mm² to 20 mm², preferably from 3.8 mm² to 12 mm², more preferably from 5 mm² to 10 mm², wherein the container further comprises the composition according to the invention. The cross-sectional surface area is measured perpendicular to the liquid exit from the container (that is, perpendicular to the liquid flow during dispensing).

The container can typically comprise from 200 ml to 5,000 ml, preferably from 350 ml to 2000 ml, more preferably from 400 ml to 1,000 ml of the liquid hand dishwashing detergent composition.

### Method of Washing

The invention is further directed to a method of manually washing dishware with the composition of the present invention. The method comprises the steps of delivering a composition of the present invention to a volume of water to form a wash solution and immersing the dishware in the solution. The wash solution is preferably at a temperature of greater than 30° C., more preferably greater than 35° C., most preferably greater than 40° C. The wash solution is typically at a temperature of less than 70° C., more typically less than 60° C. The dishware is to be cleaned with the composition in the presence of water. Optionally, the dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the detergent composition, preferably in liquid form, of the present invention diluted in water. The actual amount of detergent composition used will be based on the judgment of the user and will typically depend upon factors such as the particular product formulation of the detergent composition, including the concentration of active ingredients in the detergent composition, the number of soiled dishes to be cleaned, the degree of soiling on the dishes, and the like. Generally, from about 0.01 mL to about 150 mL, preferably from about 3 mL to about 40 mL of a detergent composition of the invention is combined with from about 2,000 mL to about 20,000 mL, more typically from about 5,000 mL to about 15,000 mL of water in a sink. The soiled dishware are immersed in the sink containing the diluted detergent compositions then obtained, before contacting the soiled surface of the dishware with a cloth, sponge, or similar cleaning implement. The cloth, sponge, or similar cleaning implement may be immersed in the detergent composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

Such methods of neat application comprise the step of contacting the liquid hand dishwashing detergent composition in its neat form, with the dish. The composition may be poured directly onto the dish from its container. Alternatively, the composition may be applied first to a cleaning device or implement such as a brush, a sponge, a nonwoven material, or a woven material. The cleaning device or implement, and consequently the liquid dishwashing composition in its neat form, is then directly contacted to the surface of each of the soiled dishes, to remove said soiling. The cleaning device or implement is typically contacted with each dish surface for a period of time range from 1 to 10 seconds, although the actual time of application will depend upon factors such as the degree of soiling of the dish. The contacting of said cleaning device or implement to the dish surface is preferably accompanied by concurrent scrubbing. Alternatively, the device or implement may be immersed in the liquid hand dishwashing detergent composition in its neat form, in a small container that can accommodate the cleaning device.

Methods:

Method for Determining Dynamic Yield Stress:

Dynamic yield stress is measured using a rheometer (such as an HAAKE MARS from Thermo Scientific, or equivalent) operated in controlled rate mode, using a 60 mm parallel plate and a gap size of 500 microns at 20° C. The dynamic yield stress is obtained by measuring quasi-steady state shear stress as a function of shear rate starting from 10 s-1 to 10-4 s-1, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. Shear stress data is then fitted using least squares method in logarithmic space as a function of shear rate following a Herschel-Bulkley model:

τ=τ₀+k\dot{γ}ⁿ

wherein τ is the measured equilibrium quasi steady state shear stress at each applied shear rate \dot{γ}, τ₀ is the fitted dynamic yield stress. k and n are fitting parameters.

Method of Measurement of the Hydrodynamic Diameter and Diameter of Fibers

Sample Preparation:

A) Microfibrous Cellulose Raw Material:

A cellulose fibers sample is prepared by adding between 1% dry matter of cellulose fibers to water and activating it with a high-pressure homogenizer (PANDA from GEA, 350 bars, 10 passes).

B) Detergent Composition Comprising Cellulose Fibers:

The detergent composition sample is centrifuged at 4,000 rpm for 10 minutes using a 5804 centrifuge from Eppendorf, in order to remove any particles to avoid interference in the measurement of the fiber size. The clarified detergent composition is then decanted as the supernatant. The cellulose fibers present in the detergent composition (supernatant) are redispersed in ethanol using an Ultra Turrax device from IKA, T25 S 25 N—25 G—ST, at a speed of 21 000 rpm for 10 minutes. Then, sample is centrifuged at 4 000 rpm for 10 minutes using a 5804 centrifuge from Eppendorf and supernatant is removed. The remaining microcellulose fibers at the bottom are analyzed. The process is repeated as many times as needed to have enough fibers for the analysis.

Measuring Hydrodynamic Diameter:

The instrument used is the Malvern Mastersizer 2000 Hydro 2000 MU particle size analyser from Malvern Instruments with the software Mastersizer 2000 version 5.60 from Malvern Instruments. The instrument cell is cleaned and then filled with demineralised water. If the background has a laser intensity above 79%, the system is considered clean and the sample can be added to the vessel until the desired obscuration is achieved. Then ultrasounds are switched on for 30 seconds and once the sample is well dispersed, the measurement can start.

Then, the volume weight mean [4,3] is measured. The hydrodynamic diameter can be obtained by dividing the volume weight mean [4,3] by 2. The hydrodynamic diameter is the diameter of the equivalent sphere that has the same translational diffusion coefficient as the fiber being measured assuming a hydration layer surrounding the fiber.

Sampler selection: Hydro 2000 MU

Sampler settings:
Pump/stir speed: 2500 rpm
Ultrasonics: 30 seconds

Material:
Refractive Index of the material: 1.53
Dispersant used: demineralised water in an amount as needed
Particle shape: Irregular

Measurement:
Measurement cycles: 3 measurements per aliquot with a delay of 10 seconds
Measurement time: 10 seconds
Measurement snaps: 10,000
Background time: 10 seconds
Background snaps: 10,000
Lower obscuration limit: 5
Upper obscuration limit: 15

Measuring Average Cellulose Fiber Diameter:

The average cellulose fiber diameter is analysed using Atomic force microscopy (AFM). A 0.02% cellulose fiber dispersion in demineralized water is prepared, and a drop of this dispersion is deposited onto freshly cleaved mica (highest grade V1 Mica, 15×15 mm—TED PELLA, INC., or equivalent). The sample is then allowed to dry in an oven at 40° C.

The mica sheet is mounted in an AFM (Nanosurf Flex AFM, ST Instruments or equivalent) and imaged in air under ambient conditions using a Si cantilever in dynamic mode with dynamic mode tip (ACTA —50—APPNANO or equivalent). The image dimensions are 20 micron by 20 micron, and 256 points per line are captured.

The AFM image is opened using suitable AFM data analysis software (such as Mountainsmap SPM 7.3, ST Instruments, or equivalent). Each image is leveled line by line. One or more profiles are extracted crossing perpendicularly one or multiple fibers avoiding bundles of fibers, and from each profile, a distance measurement is performed to obtain the diameter of the fibers. Ten diameter measurements are performed per picture counting each fiber only once.

Three sets of measurements (sample preparation, AFM measurement and image analysis) are made. The arithmetic mean of all fibers measured in all images is the Average Cellulose Fiber Diameter.

### EXAMPLES

The liquid hand dishwashing compositions, inventive Examples 1 and 2, as well as comparative examples A and B, were prepared by simple mixing of all the ingredients except for the microfibrillated cellulose. In order to provide a single variable comparison, the microfibrillated cellulose was added at levels to provide the same low-shear viscosity (at a shear rate of 1 s⁻¹) between example 1 and Example A, and between Example 2 and Example B. The microfibrillated cellulose slurry was then dispersed into the composition using a Silverson mixer with a General Purpose Disintegrating Head for 15 min at 3000 rpm. All of the compositions had a pH of 9.

| | Example 1 | Example A | Example 2 | Example B |
|---|---|---|---|---|
| | (Inventive) | (Comp.) | (Inventive) | (Comp.) |
| | wt % | wt % | wt % | wt % |
| C₁₂₋₁₃ AE_{0.6}S anionic surfactant | 12.12 | 12.12 | 12.12 | 12.12 |
| C₁₂₋₁₄ dimethyl amine oxide | 4.04 | 4.04 | — | — |
| Cocoamidopropyl betaine | — | — | 4.04 | 4.04 |
| NaOH | 0.1 | 0.1 | 0.1 | 0.1 |
| NaCl | 1.0 | 1.0 | 1.0 | 1.0 |
| Amphiphilic alkoxylated | 0.14 | 0.14 | 0.14 | 0.14 |
| polyalkyleneimine¹ | | | | |
| microfibrillated cellulose | 0.1 | — | 0.1 | — |
| derived from wood² | | | | |
| microfibrillated cellulose | — | 0.05 | — | 0.05 |
| derived from bacteria³ | | | | |
| Water + minors (preservative, | to 100% | to 100% | to 100% | to 100% |
| dye, perfume) | | | | |
| Viscosity at 1/s [mPa · s] | 4864 | 4730 | 6019 | 5897 |

The viscosity recovery of liquid hand dishwashing detergent compositions was measured using a rheometer (Haake MARS Modular Advanced Rheometer System from Thermo scientific) with a cone-plate geometry cell with a 60 mm wide, 1° cone, and a 65 micron gap. The temperature was controlled at 20° C. The sample was left to rest for 2 minutes on the rheometer cell. In a first step, the viscosity expressed in mPa·s was measured at a shear rate of 1/s. Subsequently, the following three shear cycles were applied: ¹ 600 g/mol weight average molecular weight polyethylenimine backbone, that is first ethoxylated with 24 EO and then propoxylated with 16 PO, supplied by BASF² Spruce derived, as 2 wt % active slurry, Exilva® Forte, supplied by Borregaard³ Bacterial derived, as 1 wt % active slurry, Cellulon® L88, supplied by CP Kelco

cycle 1: a shear rate of 250/s for 30 seconds, followed by a recovery period at a shear rate of 1/s for 30 seconds. In the recovery period, 100 equally spaced viscosity measurements were recorded.

cycle 2: a shear rate of 250/s for 30 seconds, followed by a recovery period at a shear rate of 1/s for 50 seconds. In the recovery period, 100 equally spaced viscosity measurements were recorded.

cycle 3: a shear rate of 250/s for 30 seconds, followed by a recovery period at a shear rate of 1/s for 80 seconds. In the recovery period, 100 equally spaced viscosity measurements were recorded.

The viscosity during the recovery period of cycle 3 was compared to the viscosity in the first step. The time required to restore 75% of the viscosity measured during the first step was determined. The experiment was replicated in threefold and the results averaged. The results are given below:

| | Example 1 | Example A | Example 2 | Example B |
|---|---|---|---|---|
| | (Inventive) | (Comp.) | (Inventive) | (Comp.) |
| time required to restore 75% of | 8 ± 1 | 52 ± 17 | 8 ± 1 | 35 ± 13 |
| the viscosity during the | | | | |
| recovery period of cycle 3 (s) | | | | |

As can be seen from the recovery times, formulating the liquid hand dishwashing detergent compositions using a wood derived microfibrillated cellulose (ex. 1, 2) in order to provide the desired low-shear viscosity, results in much faster viscosity recovery after shearing as compared to liquid hand dishwashing detergent compositions comprising a bacterial derived microfibrillated cellulose (ex. A, B). This is confirmed for both amine oxide as well as betaine based co-surfactant systems. As a result, the inventive compositions have improved phase stability and are better able to stably suspend particulates and other dispersed phases.

The following examples are provided to further illustrate the present invention:

| | Ex 3 | Ex 4 | Ex 5 | Ex 6 | Ex 7 |
|---|---|---|---|---|---|
| As 100% active | wt % | wt % | wt % | wt % | wt % |
| C12-C13AE0.6S | 20.4% | 10.0% | 9% | 20.4% | 8% |
| C12-C14 dimethyl amine oxide | 6.8% | 5.0% | 3% | — | — |
| Cocoamidopropyl betaine | — | — | — | 6.8% | 4% |
| Alkoxylated polyethyleneimine¹ | 1% | 0.5% | 0.3 | 0.5% | 0.5% |
| (EO)13(PO)30(EO)13⁴ | — | 1.5% | — | — | 0.5% |
| (EO)11(PO)21(EO)11⁵ | — | — | 1.0% | — | — |
| Microfibrillated cellulose derived from | 0.05% | 0.12% | 0.2% | 0.1% | 0.5% |
| wood² | | | | | |
| Ethanol | 2.0% | 1.0% | 2.0% | 2.0% | 2.0% |
| NaCl | 0.7% | 1.0% | 1.0% | 0.7% | 0.7% |
| Polypropyleneglycol (MW2000) | 0.7% | — | 0.7% | 0.7% | 0.7% |
| Water + Minor ingredients (perfume, | Balance | Balance | Balance | Balance | Balance |
| dye, preservatives) | to 100% | to 100% | to 100% | to 100% | to 100% |
| pH (at 10% product concentration in | 9.0 | 9.2 | 8.8 | 9.1 | 8.5 |
| demineralized water - with NaOH | | | | | |
| trimming) | | | | | |

⁴Tergitol ® L64E, supplied by DOW
⁵Pluronic ® L44, supplied by BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing detergent composition comprising:
a. from about 5% to about 50% by weight of the total composition of a surfactant system, wherein the surfactant system comprises anionic surfactant and a co-surfactant selected from the group consisting of an amphoteric surfactant, a zwitterionic surfactant and mixtures thereof; and
b. from about 0.001 to about 2.0% by weight of the total composition of microfibrillated cellulose derived from wood.

2. The composition according to claim 1, wherein the composition comprises from about 0.01% to about 1.0%, by weight of the total composition of the microfibrillated cellulose.

3. The composition according to claim 2, wherein the composition comprises from about 0.05% to about 0.5%, by weight of the total composition of the microfibrillated cellulose.

4. The composition according to claim 1, wherein the microfibrillated cellulose is derived from wood which comprises less than about 10% soluble fibre as a percentage of total fibre.

5. The composition according to claim 1, wherein the composition has a viscosity of from about 10 mPa·s to about 10,000 mPa·s, measured at a shear-rate of about 1 s⁻¹ at a temperature of about 20° C.

6. The composition according to claim 5, wherein the composition has a viscosity of from about 500 mPa·s to about 1,500 mPa·s, measured at a shear-rate of about 1 s⁻¹ at a temperature of about 20° C.

7. The composition according to claim 1, wherein the microfibrillated cellulose is derived from a wood selected from spruce, poplar, olive tree, eucalyptus, pinus, robinia, elm, oak, and mixtures thereof.

8. The composition according to claim 7, wherein the microfibrillated cellulose is derived from a wood selected from spruce, eucalyptus, and mixtures thereof.

9. The composition according to claim 1, wherein the composition comprises a polymer or suspended insoluble material

10. The composition according to claim 9, wherein the composition comprises a polymer, wherein the polymer is selected from the group consisting of: triblock copolymers, amphiphilic alkoxylated polyalkyleneimines, ethoxylated polyalkyleneimines, polyester soil release polymers, and mixtures thereof.

11. The composition according to claim 1, wherein the liquid hand dishwashing detergent composition comprising from about 10% to about 40%, by weight of the total composition of the surfactant system.

12. The composition according to claim 11, wherein the liquid hand dishwashing detergent composition comprising from about 25% to about 35%, by weight of the total composition of the surfactant system.

13. The composition according to claim 1, wherein the anionic surfactant comprises alkyl sulphated anionic surfactant selected from the group consisting of: alkyl sulphate, alkyl alkoxy sulphate, and mixtures thereof.

14. The composition according to claim 13, wherein the alkyl sulphated anionic surfactant has an average alkyl chain length of from 8 to 18 carbon atoms.

15. The composition according to claim 13, wherein the alkyl sulphated anionic surfactant has an average degree of alkoxylation of less than about 5.

16. The composition according to claim 8, wherein the alkyl sulphated anionic surfactant has a weight average degree of branching of more than about 10%.

17. The composition according to claim 8, wherein the co-surfactant is an amphoteric surfactant selected from amine oxide surfactant.

18. The composition according to claim 1, wherein the weight ratio of the anionic surfactant to the co-surfactant is from about 1:1 to about 8:1.

19. The composition according to claim 1, wherein the composition further comprises:
a. from about 0.05% to about 2% by weight of the total composition of a salt;
b. from about 1% to about 10% by weight of the total composition of a hydrotrope or a mixture thereof;
c. from about 0.01% to about 25% by weight of the total composition of an organic solvent; and
d. mixtures thereof.

20. A packaged product comprising a container having an orifice, wherein the orifice has an open cross-sectional surface area at the exit of from about 3 mm² to about 20 mm², wherein the container further comprises the composition according to claim 1.
